(19) United States
(12) Patent Application Publication
(10) Pub. No.: US 2010/0174591 A1
(43) Pub. Date: Jul. 8, 2010

(54) Data Access Engine And Graphic Interface For Portable Computer Devices

(76) Inventor: Michael DeAngelo, San Rafael, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/684,044

(22) Filed: Jan. 7, 2010

Related U.S. Application Data
(63) Continuation-in-part of application No. 11/833,861, filed on Aug. 3, 2007.
(60) Provisional application No. 61/143,064, filed on Jan. 7, 2009.

(51) Int. Cl. G06F 17/30; G06F 15/16; G06F 3/00; G06F 3/048; G06Q 30/00

(52) U.S. Cl. 705/14.4; 707/774; 709/203; 715/747; 715/834; 707/E17.109

(57) ABSTRACT

A data access engine and graphic interface for portable computer devices are disclosed. According to one embodiment a system comprises a server in communication with a network, a database in communication with the network, a device in communication with the network, and an interface displayed on the device. The interface has a nested ring structure, wherein the nested ring structure comprises a contiguous geometrical shape, and a labeled segment having a category. The contiguous geometrical shape and labeled segment are hierarchically structured.

The present application claims the benefit of and priority to U.S. Provisional Patent Application No. 61/143,064 entitled “DATA ACCESS ENGINE AND GRAPHIC INTERFACE FOR PORTABLE COMPUTER DEVICES” filed on Jan. 7, 2009, and is a continuation-in-part of co-pending U.S. application Ser. No. 11/833,861 entitled “GRAPHICAL USER INTERFACE WITH CIRCUMFERENTIALLY DISPLAYED SEARCH RESULTS” filed on Aug. 3, 2007 that are hereby incorporated by reference.

### FIELD

The field of the invention relates generally to computer systems. In particular, the present method and system is directed to a data access engine and graphic interface for portable computer devices.

### BACKGROUND

The Windows-Icon-Menu-Pointer interface designed by Xerox Park in the 1960's has dominated human-computer interaction for almost forty years. While it has served well as general mode of human-computer interaction, it has key limitations that make it less than optimal for various more complex computing objectives, including expert search, command-and-control, emergency response, real-time intelligence, training, and expert-system analytics for heuristic evolution of human-machine interaction.

Further, the computer screen presents the same visual metaphor of information as the written page, with the exception of text, image, or photo links.

This metaphor fails to fully exploit the potential advantages of an interactive and dynamic digital screen.

Limitations include:

(1) The ability, in a fundamental navigational structure, to self-alter according to real-world conditions in time and space,
(2) The ability to observe human interaction with taxonomies,
(3) The ability to change according to rules integrating (1) and (2),
(4) The ability to continuously learn through (2),
(5) The ability to present coherent conceptual maps of human thought in a single screen,
(6) The ability to eliminate page turning, scrolling and scanning,
(7) The ability to move rapidly up and down taxonomies as per (6), and
(8) The ability, in a fundamental navigational structure to be edited in real time, by a single user or in collaboration.

Other than hyperlinks embedded on such a page, the search engine locates information by operating upon the user's entry of key words or phrase. The use of the page metaphor and the search box-search result methodology present numerous problems and limitations, as does the typical layout of a folder and file system.

Limitations to the search engine method include:
Users must often scroll horizontally or vertically, or search a page in order to find a link or the next subcategory.
Long cycles of design and development can be involved in designing navigation trees on websites.
Navigation is not designed by the person or the group most likely to use it.
Pages are generally inert in their menu structure and navigation path, not continuously updated in their navigation trees in real-time or near real-time by a database or a rules-based database.
Once a unique interface is built, or built and continually updated or edited, that interface is not available on, or not synchronized with various mobile devices or wireless display screens.
Interfaces can not alternate in near real-time, for the user, between using that interface, and editing it.
For large file systems, the folders can number in the thousands, and not be readily available to manual review or discovery.
A users interaction cannot be observed easily, or observed in its fundamental intent, or observed in a pure model of interaction designed by the potential observer.
There no area of clear focus on the digital screen.
Advertisements are not seen as integral to the navigation path to desired information.
Advertisements are not seen as an equal and viable option to the possibilities presented in the navigation path to desired information.

### SUMMARY

A data access engine and graphic interface for portable computer devices are disclosed. According to one embodiment a system comprises a server in communication with a network, a database in communication with the network, a device in communication with the network, and an interface displayed on the device. The interface has a nested ring structure, wherein the nested ring structure comprises a contiguous geometrical shape, and a labeled segment having a category. The contiguous geometrical shape and labeled segment are hierarchically structured.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the invention.

### BRIEF DESCRIPTION

The accompanying drawings, which are included as part of the present specification, illustrate the presently preferred embodiment and together with the general description given above and the detailed description of the preferred embodiment given below serve to explain and teach the principles of the present invention.

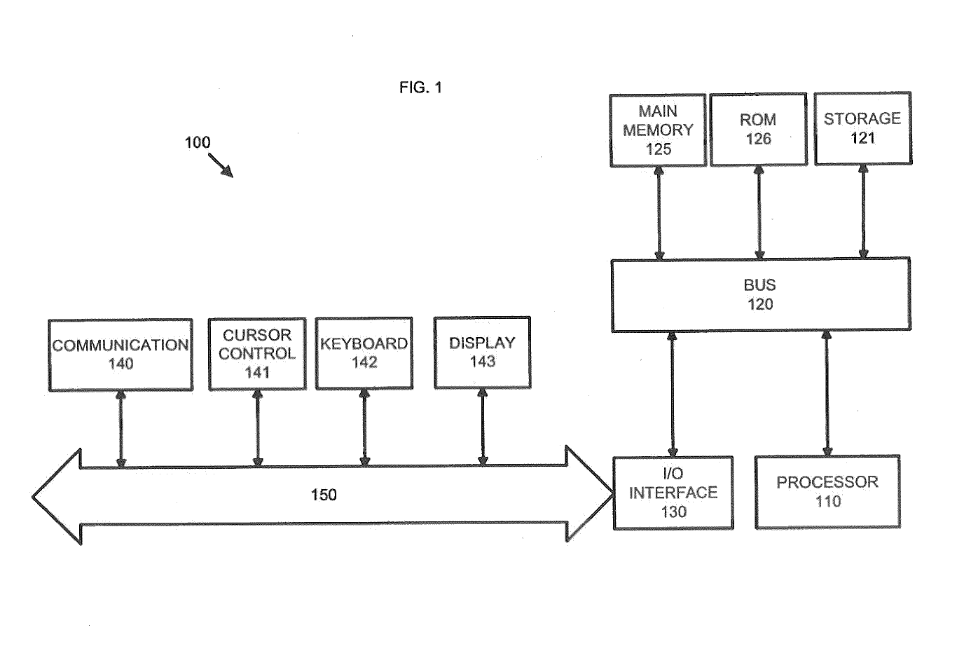

FIG. 1 illustrates an exemplary computer architecture for use with the present system, according to one embodiment.

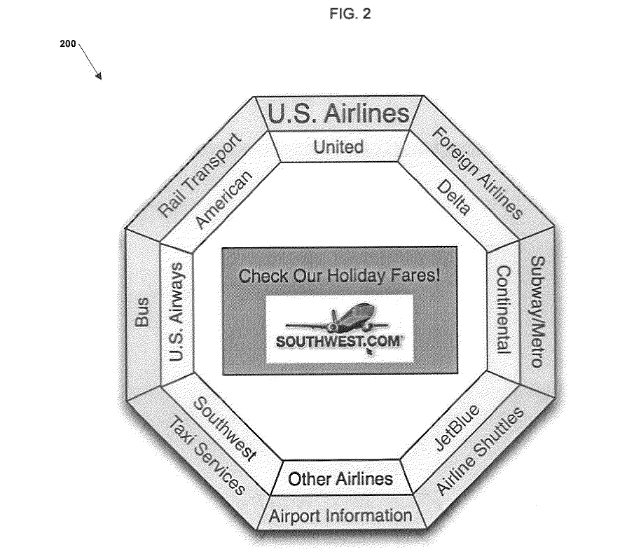

FIG. 2 illustrates an exemplary user interface for use with the present system, according to one embodiment.

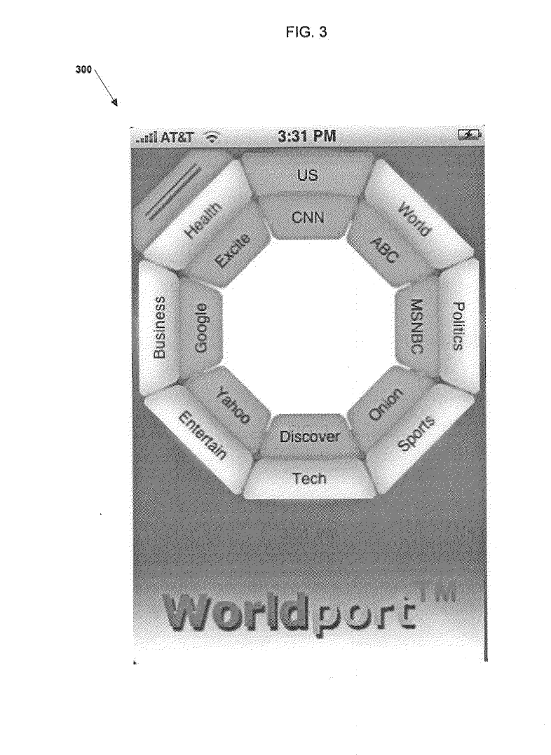

FIG. 3 illustrates an exemplary interactive graphical category depth tab feature for use with the present system, according to one embodiment.

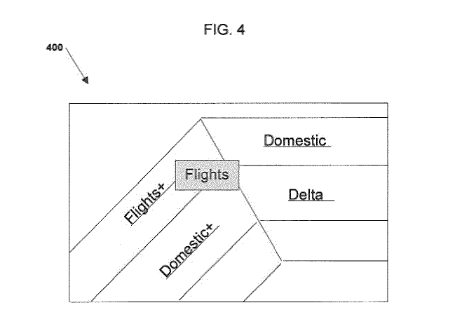

FIG. 4 illustrates an exemplary tab Level Indicator with pop-up text indicator for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A data access engine and graphic interface for portable computer devices are disclosed. According to one embodiment a system comprises a server in communication with a network, a database in communication with the network, a device in communication with the network, and an interface displayed on the device. The interface has a nested ring structure, wherein the nested ring structure comprises a contiguous geometrical shape, and a labeled segment having a category. The contiguous geometrical shape and labeled segment are hierarchically structured.

The present system includes a graphical user interface, database, and rules system for providing rapid organization and identification of information resources and commands through their organization in an information tree embedded in a nested ring structure of contiguous geometric shapes to allow for an apparatus for a digital display screen for rapidly identifying information through a continuous drilling down through categories and subcategories to reach files, Web links, Web content or function calls, allowing the human editor and user, and the computer expert system, alone or in combination, to more easily and readily develop, use, and evolve coherency, responsiveness and rudimentary intelligence, and allowing the human user to alternate between use and editing, where the human editor can easily build trees of categories and subcategories that lead to the selection of Web links, system files, or function calls. The interface can be continuously updated by observation of individual or collective user action and the applications of pertinent rules.

In the present system, contiguous geometric shapes are presented in a nested ring structure, allowing the user to drill down without limitation through categories and subcategories in an organized tree to reach a selection of Web links, Web content, or function calls by selecting a text, audio, or graphic label in the individual segments of the geometric shapes in the ring structure.

The use of the display can alternate between using it as described in the above paragraph, or using an editor to fill our forms to populate individual segments of the geometric shapes with a category or subcategory by a text, audio or graphic label. An icon or button on the individual segments allows the user to alternate between editing or populating the interface, and using the interface.

The central enclosed space can be used for an advertisement, or email address capture. The labeled segments can also be a sponsored selection, leading to the particular web site, content, or advertisement of the sponsor.

The present system also includes an interface of contiguous geometric shapes with labeled segments, and allows alternating between using and editing, and forms to input links or categories or function calls.

The present system also provides a back end database which can reside with an individual user, or an individual interface.

The present system also transfers or synchronize categories, labels, links and functions over a server in order to reside with a specifically populated interface.

The present system also jumps from one ring level to any other ring level.

The present system also ascends and descends through hierarchical levels of the ring structures, or categories and subcategories.

The present system also replaces the category labels of one ring with the category levels of a parent or child ring.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method. The required structure for a variety of these systems will appear from the description below. In addition, the present invention is not described with reference to any particular programming language. It will be appreciated that a variety of programming languages may be used to implement the teachings of the method and system as described herein.

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 127 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

FIG. 2 illustrates an exemplary user interface for use with the present system, according to one embodiment. According to one embodiment, a graphical user interface 200 allows the user to alternate to an edit mode to populate the segments of the interface 200 with category labels of any communicating nature, such as graphic, photo, text, audio, etc.

The interface 200 can be used as the basis of an application to help users access various Travel data sources on their mobile phone, for example. An interface 200 includes several elements. It includes a segmented outer ring with a number of options the user can select between, using the selection methods available on the specific mobile phone, or the specific computer screen or device. Options for the selection include direct finger access of the display screen, positioning of a mouse cursor over the specific selection, clicking, voice commands, and keyboard typing of the specific option, neural-electrical stimulation or any current or future way of activating a selection. The interface 200 display also includes a second level of options displayed in an inner ring. In this example, these options are displayed based on the specific selection the user has made, or in the case of a mouse hover, is about to make, in the outer ring. As a result, when the user has selected “U.S. Airlines”, a list of “U.S. Airline” options are displayed in the inner ring.

The interface 200 display also includes, by example, a center display item that is an advertisement provided by Southwest Airlines promoting special holiday fares (in this example). Each individual segment shown on the interface 200 is intended to be accessible and selectable by the user.

The portable device displaying the interface 200 has access to a database of information to be accessed and then converted into other graphical information when the user selects a specific segment of the interface 200. The software application that includes the interface 200 includes both a locally available set of data installed within the device and the ability to access remote data needed by the device. For purposes of the present illustration, the locally available data might be edited by a user to include, in the Travel application described above, the following information:
A list of all U.S. airlines, to be displayed on an inner ring when the outer ring “U.S. Airlines” segment is selected,
A list of all foreign airlines, to be displayed on an inner ring with the outer ring “Foreign Airlines” segment is selected, and
Similar options for the other Outer Ring examples shown in FIG. 1.

In addition, the present system locally stores data for yet another layer or several layers of data below the hierarchies already shown in the interface 200.

In addition, the present system accesses specific information stored remotely from the portable device. Examples of this kind of information for an airline, include but are not limited to Flight Status information, a mechanism for enabling mobile Flight Check-In, and Fare Selections. Remote databases are accessed via a wireless data connection to the Internet.

The combination of both local as well as remote data access is what is referred to here as the Data Access Subsystem. The Data Access Subsystem and the interface 200 are used together in mobile devices, or computers, on the desktop, internet, or intranets.

Exemplary access is as follows. A user has a travel application installed on his mobile device. Access to the interface 200 is handled by moving a cursor over the GUI and then clicking. The user can access the application by clicking on an icon on the screen, which opens the application. In moments the display shown in FIG. 2 appears. The user, who might be looking to determine fares and flight times for a flight on Continental Airlines, for example, first moves the cursor to the U.S. Airlines segment on the outer ring and then clicks on that segment.

The interface 200 then switches to the inner ring of U.S. Airlines as displayed in the figure. A central advertisement display, promoting Southwest Airlines, also appears on the device at this time, triggered as well by the selection of “U.S. Airlines”. That central advertisement display might be stored in a special database managed directly by the airline, by the device manufacture, or some other database designed to provide such feeds for the device. In this example, the user then moves the cursor to Continental Airlines and clicks on it.

In the preferred embodiment, the previously inner ring with the list of airlines becomes the outer ring. A new inner ring of options displays, generally a set of options representing a subset of the selected label segment. The new inner ring can include options such as Flight Schedules, Flight Check-In, Change Itinerary, and others, all of which would be uniquely tied to the Continental Airlines selection made previously. The data for all the information displayed on the device so far is from a previously downloaded database already installed on the portable device.

When the user then clicks on the “Flight Schedules” link the device either accesses an accompanying data file, a specific loaded temporary file, or sends out a request to access remote data from a Continental Airlines computer server, by wireless connection to the internet. That data, once received or accessed, is displayed on the user's mobile device. It can be displayed within the mobile device's own browser window, a computer screen, a computer browser window, an industrial control digital display screen, or within a pre-formatted display that is provided by the graphical user interface 200.

It is possible that some or all of the data related to Continental Airlines is part of the locally stored data on the device, and only some of the real-time data needs to be accessed remotely.

Besides selecting Continental Airlines, the user can optionally choose to select the Advertisement box in the center of the interface 200 instead. In this case a separate set of options related to that advertisement are displayed, either in a new set of nested rings provided by the interface 200 or in the mobile device's browser window.

Because the locally-stored database is kept as current as possible, the present system monitors whether or not the data needs updating, by accessing a remote data file from the mobile device. According to one embodiment, if the data needs updating, the device updates its internal database automatically in the background, so that it is always ready for the next use.

In the preferred embodiment, this sync process proceeds as follows. The moment the mobile device is turned on (and even before the user might access the application on the device) The portable device might remotely access a database server storing all downloadable application data for the application. If the data is not current, it could download that data onto the device.

Conventional portable applications for accessing remote data on a portable device require direct access during data access process. With prior systems the same user would have had to first open his mobile device's mobile browser, connect to the internet, enter the URL or bookmark for the site or sites he was interested in, wait until those pages loaded, choose from the included options, wait for the next level of pages to load, and so on, until the user finally reached the page with the real-time data he needed to access.

The interfaces used by many of these mobile sites are often text-based and with awkward search processes, accessing of the remote sites takes a considerable amount of time. By providing an improved GUI as well as providing a combination of a constantly-updated local database plus remote connectivity to databases only for the final steps of a data search, the current system dramatically speeds access to the data on the device.

FIG. 3 illustrates an exemplary interactive graphical category depth tab feature for use with the present system, according to one embodiment. A special interactive graphical category depth tab feature 300 makes it easier for a user to navigate the interface 200, to determine the present level of the hierarchy, and to move up and down within the levels or jump to different levels. According to one embodiment, the feature 300 is located such as located just outside the “Health” selection on the outer ring.

When a user selected the “Health” option, the tab 300 appears alongside that choice. Graphical information such as a set of lines or shapes or text would communicate to the user the level of the hierarchy they are searching at this moment. In the example shown above, the two lines in the tab 300 indicate this is a “second level” of search in the hierarchy.

The interface 200 also allows each segment of the ring to change what it displays, in colors, or in graphic images, or as text, or any combination of these when the user cursor or equivalent hovers over or clicks on the display.

The interface 200 also advantageously provides a functionality such that the changed display could stay highlighted when the next nested ring is accessed, and that a variety of graphic images might be used to help users more quickly determine what to access. These images can include photos, pictures of landmarks, audio, and graphical icons, among others.

The interface 200 also advantageously provides other areas of the graphical display, beyond what were described earlier in this document, which can be accessed and clicked on by the user, including spaces between the nested rings and outside the nested rings

The interface 200 also advantageously provides the ability for a user to hover over or select a specific element of the display and a kind of user entry form can appear on the screen, where appropriate.

It is optionally not necessary to click on a segment for the interface 200 to shift to the new set of nested rings. Instead it may be that simply hovering for a minimum length of time over a given segment will cause the interface 200 to shift.

The user may communicate with the interface 200 using voice commands, according to one embodiment.

According to one embodiment, the user may communicate with the interface 200 by reading brain impulses, including electroencephalography—EEG—as just one example.

The interface 200 also advantageously provides the following capabilities, according to one embodiment.
The nesting of rings is not hierarchical at all, but instead displays more data in two separate rings.
The center display region can provide other information about the segment the user is hovering over but has not yet selected.
The user may access the data by entering text through the portable device's text input mechanism.
The user may conduct a text-based search on the device and the information resulting from that search, instead of being displayed as a tabular array of items such as is currently provided by conventional mobile search engines, would display the results of that search in a GUI of nested rings.
The user may be able to restructure the interface 200 manually by selecting elements of the rings and “dragging and dropping” them to a new desired location within the interface 200 on the portable device.
The nested shapes of the interface 200 are rings, but do not need to be rings but could be other shapes.
The division of the shapes is into eight equal segments, but the number of the segments could be more or less, and not be equal.

The data access subsystem advantageously provides the following capabilities, according to one embodiment.
The data access subsystem logs the user's most recent use of the interface 200 and set that as the default beginning display state for the interface 200 when the application is started up the next time;
The data access subsystem displays data in the nested rings of category labels based on the user's most frequent accesses on the device;
The data access subsystem displays data in the nested rings based on the most popular accesses of any uniquely populate interface based on data gathered remotely from all users of this particular populated interface on their own devices;
The data access subsystem displays data in the nested rings based on specific user-entered preferences for those display items;
The data access subsystem displays advertisements anywhere within the interface 200, including on the nested ring structures;
The data access subsystem advertisements are provided from a central advertising server serving all devices;
The advertisements may change automatically based on the set of user selections that user has and is currently exploring;
Data and options to be displayed within the interface 200 are determined in part based on the known location of the portable device that displays the application. The location information is determined using the device's internal GPS data, from cell tower location data, or other information transmitted to the device;
A user may use the interface 200 to access a remote or local file database, edit that file, and then store the end result;
Data accesses and updates are automatically logged by the application's internal database;
All data accesses and updates are automatically logged by the application's remote database;
Data accessed by the device may be controlled by stored or requested-on-demand passwords for the device;
Data accessed by the device may include that stored in what are currently called “Social Networks”, such as Facebook, MySpace, Linkedln, or others;
The user inputs specific filtering criteria that limits the nature and quantity of data to be accessed by the device;
The data to be displayed in the interface 200 is based on past purchases made by the user on this mobile device, or based on purchases logged in a remote database. This data may include specific segment options in the nested rings, targeted advertisements, or both.
The data to be displayed in the rings is controlled by a network administrator.

An example of this might be in a company-deployed mobile phone application, where the company wishes to display specific information related to that company's needs on its employees' phones.
The interface 200 information and results to be displayed can be the result of a collaborative communication and linkage between two different mobile devices. An example could be if one user in one location has created a specific user-defined interface 200 data structure on his phone and is willing to share that with an authorized second user. A second example would be if a first user were to have conducted a specific search with unique displayed results and is willing to share that with an authorized second user.
The ring level or depth is visible in an interactive manner such that the user might jump between the levels of the ring rather than move consecutively.

The present system also allows the user to alternate with an interactive selection, between use and editing of the interface 200.

The present system also populating the labeled segments of the interface with links to Web page, Web links, Web content, or function calls on the local device, system, or desktop, or on the Internet once editing is selected.

The present system also populates the labeled segments of the interface with links to Web page, Web links, Web content, or function calls on the local device, system, or desktop, or on the Internet according to the kind of file or link they are, such as video, audio, or text once editing is selected.

The present system also advantageously provides for the interface 200 to replace the categories in the labeled segments of one ring of a digital display of contiguous geometric shapes in a nested ring structure by the subcategories of any particular category label in that ring so that the user can move through an infinite number or rings and sets of subcategories.

The present system also advantageously provides the user with the ability to alternate between use and editing of this interface using a switch.

The present system also advantageously provides for the use of the central enclosed space or any segment anywhere in the labeled segments of a ring for an advertisement or email capture.

The present system also advantageously provides the user with the ability to alternate between using the interface to navigate to categories, content links, or function calls, and editing (populating) the interface with their own chosen categories, content links or function calls.

The present system also advantageously provides the system with the ability to synchronize the nested search structure with an external database to populate and update the segment labels, by a simple fetch of information or the application of a rules-based system of observation and alteration, including synchronization between desktop devices and mobile devices.

The present system also advantageously provides the user with the ability to choose a desired content filter, such that in a ring of links to content, only links matching the filter, such as audio, or video, or text, is displayed.

FIG. 4 illustrates an exemplary tab level indicator with pop-up text indicator 400 for use with the present system, according to one embodiment.

By presenting in a digital interface a human-designed knowledge or navigation tree in contiguous interactive geometric shapes, the digital interface can move beyond these limitations, including eliminating scrolling, horizontal and vertical scanning, and page searching, allowing the human editor and user, and the computer expert system, alone or in combination, to more easily and readily develop, use, and evolve coherency, responsiveness and rudimentary intelligence. By alternating between use and editing, the human editor can easily build trees of categories and subcategories to lead to Web links, Web content, system files, or function calls. The interface can be continuously updated by observation of individual or collective user action and the applications of pertinent rules.

A data access engine and graphic interface for portable computer devices have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

I claim:

1. A system, comprising:
a server in communication with a network;
a database in communication with the network;
a device in communication with the network; and
an interface displayed on the device, the interface having a nested ring structure, wherein the nested ring structure comprises
a contiguous geometrical shape; and
a labeled segment having a category, wherein the contiguous geometrical shape and labeled segment are hierarchically structured.

2. The system of claim 1, wherein the category has a subcategory.

3. The system of claim 2, wherein the category is replaced by the subcategory.

4. The system of claim 1, wherein a user edits the interface.

5. The system of claim 1, further comprising a central enclosed space.

6. The system of claim 5, wherein the central enclosed space displays an advertisement.

7. The system of claim 1, wherein the labeled segment displays an advertisement.

8. The system of claim 5, wherein the central enclosed space displays an email capture.

9. The system of claim 1, wherein the labeled segment displays an email capture.

10. The system of claim 1, wherein the interface further comprises links.

11. The system of claim 1, wherein the interface further comprises functions.

12. The system of claim 1, further comprising a nested search structure, wherein the nested search structure synchronizes with the database.

13. The system of claim 1, wherein a user filters displayed content.

14. The system of claim 13, wherein displayed content is one or more of audio, video, and text.
